(19) United States
(12) Patent Application Publication
(10) Pub. No.: US 2002/0191197 A1
(43) Pub. Date: Dec. 19, 2002

(54) Method and apparatus for optical multi-angle endpoint detection during chemical mechanical planarization

(76) Inventors: Thomas F.A. Bibby JR., St. Albans, VT (US); Mark A. Meloni, Flower Mount, TX (US); Jeffrey Garcia, Chandler, AZ (US)

Correspondence Address: Laura J. Zeman, SNELL & WILMER L.L.P., One Arizona Center, 400 East Van Buren, Phoenix, AZ, 85004-2202, US

(21) Appl. No.: 09/881,356

(22) Filed: Jun. 14, 2001

(51) Int. Cl. G01B 11/28

(52) U.S. Cl. 356/630

(57) ABSTRACT

A method and apparatus for optical multi-angle in situ CMP endpoint detection include a sensor block having light emitting channels, light receiving channels and an opening where the light emitting channels terminate and the light receiving channels originate and means for determining endpoint based on the amount of reflected light that is received from the light receiving channels. At least a portion of the sensor block is embedded in a polishing pad backer such that the light emitting channels can emit light through a polishing pad window to the surface of a wafer and the light receiving channels can receive light reflected from the wafer surface through the polishing pad window. Connectors may be used to connect a light source to the light emitting channels and a light detector to the light receiving channels. Further, fiber optic cables may be used between the light emitting channels and the light receiving channels and their respective connectors in order to facilitate transporting emitted and reflected light to the light source and light detector which are each positioned.

### FIELD OF INVENTION

The present invention generally relates to a method and apparatus for optical in situ endpoint detection during chemical mechanical planarization (CMP). More particularly, the present invention relates to a method and apparatus for optical multi-angle in situ endpoint detection for CMP.

### BACKGROUND OF THE INVENTION

Planar surfaces are required in the manufacture of semiconductors because the size of the devices and interconnects used to build semiconductors continue to rapidly decrease. Therefore, if the surface of a wafer is not planar during the semiconductor fabrication process, the risk of producing failed devices increases. The chemical mechanical planarization of workpieces, and particularly wafers, usually involves pressing the surface of a wafer against a polishing surface, typically a polishing pad, that is attached to a rotating or orbiting platen in the presence of a slurry. During the planarization process, data relating to the condition of the wafer's surface is often recorded in order to determine endpoint, i.e. when the polishing should be stopped or interrupted. In-situ systems are generally preferred in determining endpoint.

A common optical technique for determining endpoint involves the process of reflecting light off the surface of a wafer and capturing the reflected light by a properly positioned receptor. The receptor transmits the reflected light through a fiber optic cable to a metrology instrument that analyzes data. Examples of optical endpoint methods measuring in-situ reflectivity can be seen in U.S. Pat. No. 5,433,651 and PCT International Publication Number WO 99/23449.

However, optical endpoint detection does have several drawbacks or disadvantages. First, wafers are typically planarized face down on a polishing pad which makes it difficult to achieve direct optical communication with the surface of the wafer. Therefore, in order to detect the wafer so that measurements can be taken, holes, windows or transparent areas must be manufactured into the polishing pad, or alternatively, the wafer must travel over the edge of the polishing pad. Both of these options possess the risk of introducing undesirable variables.

Second, slurry is generally used in CMP and in some cases the slurry may totally block the optical signal. Third, the constant relative motion between the wafer and the polishing pad makes it difficult to take repeatable measurements at the same point on a wafer's surface. Fourth, measurements of the wafer's surface must be taken and analyzed quickly in order to utilize results.

Optical systems including sources and detectors are typically positioned in the platen of a CMP apparatus to perform endpoint detection through a window contained in the polishing pad. To reduce downtime in the event of an error or malfunction in the optical system, it is desirable to place the optical system in a position within the CMP apparatus that is more easily accessible for repair and replacement. Furthermore, given the limitations that exist with respect to optical endpoint determination, there is a need to optimize accuracy and increase efficiency of endpoint detection using optics. One such method for optimizing endpoint detection includes the use of a multiple emitter-detector sensor assembly which involves emitting multiple angles of light on a wafer surface and detecting multiple angles of light reflected from the wafer surface. Positioning this type of optimal sensor in a position within the CMP apparatus and close to the wafer surface where it is easily accessible further optimizes the endpoint detection process. An example of one such location within the CMP apparatus is within a polishing pad backer.

Accordingly, there is a need for a method and apparatus which involves positioning a multiple angle sensor within a polishing pad backer without adversely affecting process performance and without requiring costly redesigns of the polishing pad backer.

### SUMMARY OF THE INVENTION

The present invention enhances “platen based” endpoint detection, where platen refers to a traditional hard platen or flexible platen, to provide state of the art equipment in through the table endpoint detection. In order to carry this out, a multi-angle sensor assembly is inserted or positioned within a polishing pad backer that utilizes a polishing pad having a window for endpoint detection. The present invention experiences negligible adverse impact on process performance. In addition, the present invention may take the form of an integrated sensor assembly that can be easily manufactured and which produces repeatable performance.

The entire endpoint detection assembly is shrunk in an on-lay process to fit a multi-angle sensor assembly within a limited amount of space within the polishing pad backer and thereby avoids costly redesigns of the polishing pad backer. More specifically, optical channels are formed within a sensor block and, using an in-lay process, optical waveguides are formed that couple light from a light emitting means, to a through-hole window in a polishing pad, and then to a light detecting means via light emitting channels and light detecting channels positioned in the sensor block.

One exemplary embodiment of the apparatus of the present invention for CMP in situ endpoint detection includes a sensor block positioned in a polishing pad backer which has at least one light emitting channel and at least one light receiving channel and means for determining the CMP endpoint based on the amount of light received by the light receiving channel.

The sensor block may be formed by molding a housing assembly having two halves where each half contains a set of grooves and then securing the two halves together so that their grooves lie adjacent to one another to form the two types of channels, namely the light emitting channels and the light receiving channels.

In one aspect of the invention, the sensor block includes an opening where the light emitting channels terminate and the light receiving channels begin. The opening may be filled with an optically clear material and is placed directly beneath the window contained in a polishing pad during polishing.

In another aspect of the invention, the light emitting and receiving channels are fiber optic cables or, alternatively, they are coated with a reflective coating and filled with an optically clear material. Connectors may also be used for connecting means for emitting light to the light emitting channels and means for detecting light to the light receiving channels.

In still another aspect of the invention, fiber optic cables embedded in the polishing pad backer are used to connect the light emitting channels with the light emitting means and the light receiving channels with the light detecting means.

In another exemplary embodiment of the endpoint detection apparatus of the present invention, a sensor assembly is formed from a single mold where one portion of the sensor assembly is embedded in the polishing pad backer directly beneath the polishing pad window and another portion of the sensor assembly which contains light emitting and light receiving channels is positioned behind the polishing pad backer such that it lies between the polishing pad backer and the backing plate.

In an exemplary method of the present invention for in situ endpoint detection during CMP, a sensor block having at least one emitting and detecting channel is positioned in a polishing pad backer, a polishing pad having a window is positioned over the pad backer so that ends of the light emitting and detecting channels lie adjacent the window, a light is emitted through the light emitting channel during CMP, light reflected from the wafer surface during CMP is detected from the light detecting channels, and endpoint is determined based on the light reflected from the wafer surface.

### BRIEF DESCRIPTION OF THE DRAWINGS

A more complete understanding of the present invention may be derived by referring to the detailed description and claims when considered in connection with the following illustrative Figures. In the following Figures, like reference numbers refer to similar elements throughout the Figures.

FIG. 1 is a side view of a sensor block embedded in a polishing pad backer in accordance with the apparatus of the present invention;

FIG. 2 is a cross-sectional view of an exemplary embodiment of a sensor block in accordance with the apparatus of the present invention;

FIG. 3 is a top view of a molded, partially formed sensor block in accordance with the exemplary embodiment of a sensor block of the present invention shown in FIG. 2;

FIG. 4 is a schematic of an exemplary embodiment of the apparatus of the present invention for in situ endpoint detection during CMP;

FIG. 5 is a schematic of another exemplary embodiment of the apparatus of the present invention for in situ endpoint detection during CMP; and

FIG. 6 is a flowchart showing an exemplary method for making an apparatus of the present invention for in situ endpoint detection during CMP.

### DETAILED DESCRIPTION OF EXEMPLARY EMBODIMENTS

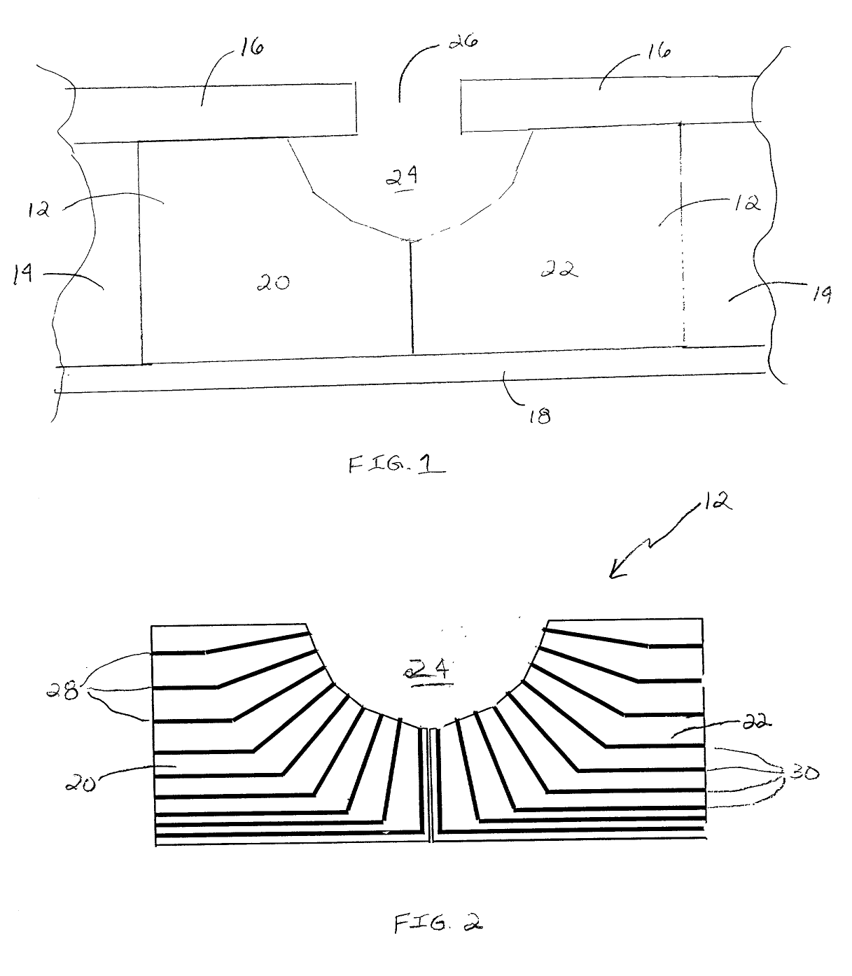

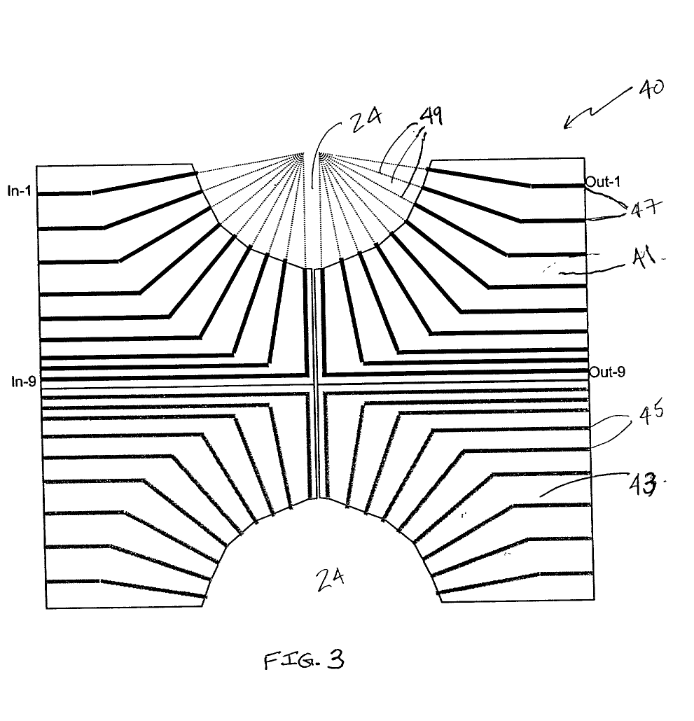

It should be understood that the particular embodiments shown and described are illustrative of the invention and its best mode and are not intended to otherwise limit the scope of the present invention in any way. The apparatus of the present invention includes a sensor block which is embedded in a polishing pad backer. FIG. 1 shows a side view of a sensor block 12 embedded in a polishing pad backer 14 that is contained between a polishing pad 16 and a backing plate 18. Sensor block 12 includes a first side 20 which houses channels for transporting emitted light (see FIG. 2) and a second side 22 which houses channels for transporting light reflected from the wafer surface (see FIG. 2). An opening 24 in sensor block 12 traverses both sides 20 and 22 and is placed directly beneath the window 26 contained in polishing pad 16 during CMP.

A cross-section of sensor block 12 in FIG. 1 is shown in FIG. 2. FIG. 2 shows that sensor block 12 is a nine emitter-detector sensor in that it includes nine light emitting channels 28 in side 20 and nine light receiving or detecting channels 30 in side 22. Light emitting channels 28 transport light to opening 24 in sensor 12. Accordingly, light emitting channels 28 terminate at opening 24 and the light transported through emitting channels 28 travels through opening 24 and is directed through window 26 of polishing pad 16 to the wafer surface (not shown). Similarly, light receiving channels 30 transport light reflected from the wafer surface to a light detector (not shown). Light reflected from the wafer surface is directed through opening 24 of sensor 12 and into light receiving channels 30.

Various methods may be used to form sensor block 12. One exemplary method involves molding a housing assembly having first and second halves containing grooves. The halves are then aligned and secured to one another to form two different types of channels, namely light emitting channels 28 and light receiving channels 30 as shown in FIG. 2.

FIG. 3 shows a top view of a molded, partially formed nine emitter-detector sensor of sensor block 12 shown in FIG. 2. A housing assembly 40 having first and second halves 41 and 43 is molded from one piece. The one piece housing assembly mold is preferably comprised of a plastic material such as modified acrylics, urethanes, Teflon fluoropolymers and other like materials that are lightweight and flexible, and possess an ANSI durometer 40-80 Shore D. However, it should be noted that the hardness of the plastic material should be comparable to that of the surrounding material. For example, if the housing is embedded in a rigid platen, the plastic material may be considerably harder than that used if the housing were embedded in a pad backer. The one piece housing assembly 40 is molded so that grooves 45 are formed in both first and second halves 41 and 43 for forming channels 28 and 30 (see FIG. 2). Fiber optic cables 47 may be placed in the grooves 45 of either first and second halves 41 and 43. The dark lines in FIG. 3 represent fiber optic cables 47 that have been placed in grooves contained in first half 41. Grooves 45 contained in second half 43 of housing 40 then function as mating grooves for the fiber optic cables 47. Each of first and second halves 41 and 43 of housing 40 contain grooves that will form both light emitting channels and light receiving channels. Once the fiber optic cables 47 are secured in grooves contained in one half of housing 40, the entire housing 40 is folded so that first and second halves 41 and 43 are adjacent one another. The resulting sensor block 12 includes light emitting channels in side 20 and light receiving channels in side 22. Dotted lines 49 indicate the directionality of the lines 47.

In another exemplary embodiment of the sensor block 12 of the apparatus of the present invention, grooves 45 are formed in both first and second halves 41 and 43 as in the previously described exemplary embodiment, but unlike the previously described exemplary embodiment, fiber optic cables are not placed into grooves 45. In stead, grooves 45 contained in both first and second halves 41 and 43 are coated with a reflective coating such as aluminum, gold, aluminum coated with a dielectric such as SiO₂, copper coated with an oxidation inhibitor or film stacks with the property of total internal reflection, and like materials or combinations of materials that function to reflect light from the walls of grooves 45. Once coated, grooves 45 are then filled with an optically clear plastic material such as epoxy, polycarbonate, silicone, acrylic polycarbon, polymethylmethacrylate (PMMA) or like materials.

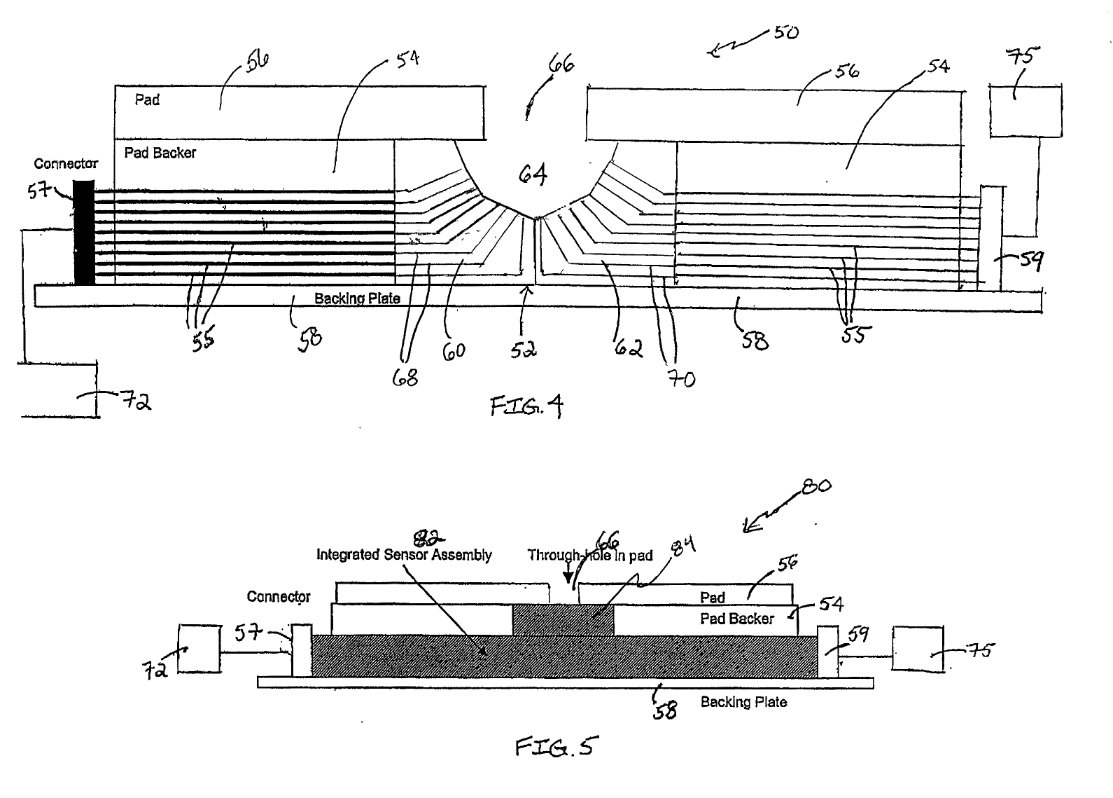

Turning now to FIG. 4, a schematic of an exemplary embodiment 50 of the apparatus of the present invention for in situ endpoint detection is shown. FIG. 4 shows an embedded integrated sensor block 52 in a polishing pad backer 54 with two sets of nine fiber optic cables 55 leading to bulk connectors 57 and 59 which are positioned on opposite sides of the pad backer 54. Sensor block 52 is embedded in pad backer 54 and, like pad backer 54, is sandwiched between polishing pad 56 and backing plate 58.

Sensor block 52 comprises a nine emitter-detector sensor like that previously described with reference to FIGS. 2 and 3. Sensor block 52 includes first and second sides 60 and 62 which each include nine light emitting channels 68 and nine light receiving channels 70, respectively. Sensor block 52 also includes an opening 64 traversing both first and second sides 60 and 62 such that light emitting channels 68 terminate at opening 64 and light receiving channels 70 begin at opening 64. When the in situ endpoint detection system of the present invention is employed, waveguides are formed which couple light from a light source 72, to connector 57, to a first set of fiber optic cables 55, to light emitting channels 68 in sensor block 52, to opening 64 in sensor block 52, through window 66 in polishing pad 56, and onto a wafer surface that is being polished, and also couple light reflected from the wafer surface back through window 66 in polishing pad 56, back through opening 64 in sensor block 60, into light receiving channels 70 contained in sensor block 52, into a second set of fiber optic cables 55, to connector 59 and to light detector 75.

Fiber optic cables 55 can be placed in trenches in the pad backer 54 but are preferably encased in a compliant, protective sheath that terminates in either connector 57 or 59 located just outside the pad backer 54. Connectors 57 and 59 are typically comprised of hard plastics and/or non-corrosive metal for a CMP environment. Many different types of connectors can be obtained from AMP, Amphenol, and Molex corporations. Light source 72 preferably comprises a semiconductor laser or other light source capable of providing monochromatic or whitelight while light detector 75 preferably comprises a laser detector or whitelight detector.

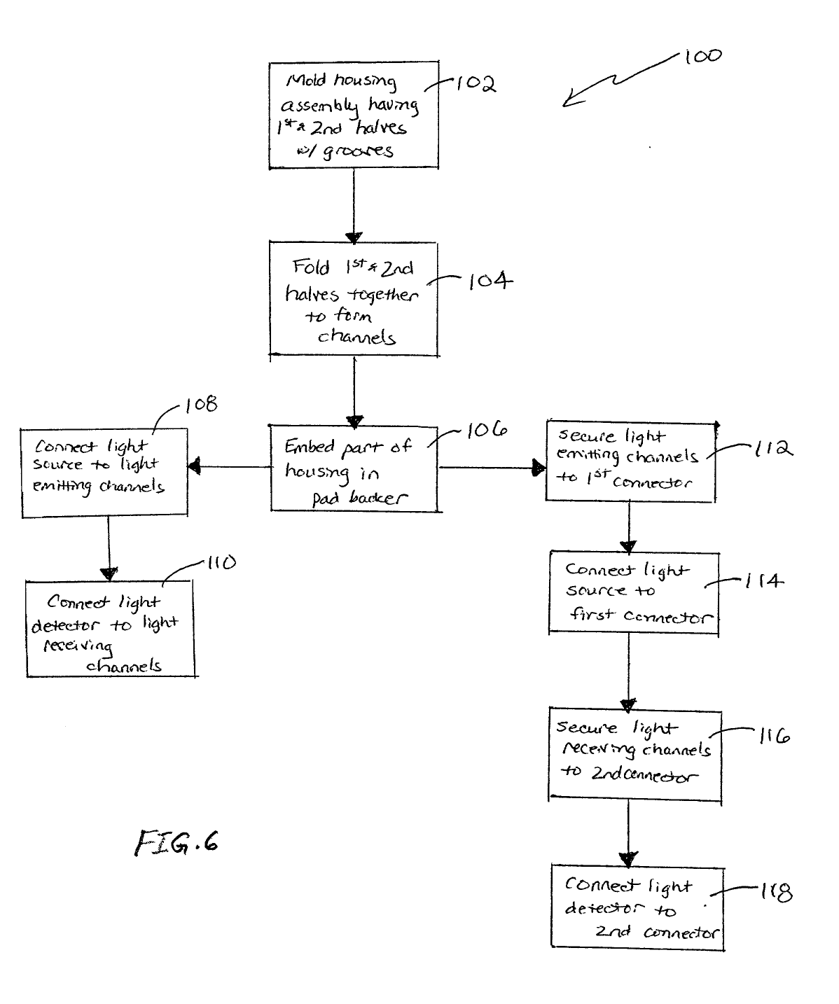

A schematic of another exemplary embodiment 80 of the apparatus of the present invention for in situ endpoint detection is shown in FIG. 5. Exemplary embodiment 80 is directed to an integrated sensor assembly 82 which includes connectors 57 and 59, fiber optic cables 55, and sensor block 52 which contains light emitting channels 68, opening 64 and light receiving channels 70. (see FIGS. 2 and 4) This integrated sensor assembly 82 is formed from a single mold and inserted into the back of the pad backer 54 prior to mounting the backing plate 58 to the integrated sensor assembly and pad backer 54. A portion 84 of integrated sensor assembly 82 which includes part of sensor block 52 having opening 64 is embedded in pad backer 54 immediately underneath window 66 in polishing pad 56. The rest of integrated sensor assembly 82 is positioned behind pad backer 54. Fiber optic cables 55, light emitting channels 68 and light receiving channels 70 may all be formed like the light emitting channels and light receiving channels previously described with reference to FIGS. 2, 3 and 4. Light source 72 and light detector 75 are positioned outside of the polishing pad backer 54 .

FIG. 6 shows a flowchart for an exemplary method 100 for making the CMP in situ endpoint apparatus of the present invention. First, in step 102, a housing assembly is molded from a single piece of material that has first and second halves with each half having grooves formed within it. Next, the first and second halves of the molded single piece are folded together in step 104 after placing fiber optic cables in the grooves or coating them with a reflective coating. The halves are secured to one another so that the grooves contained in each of the halves are adjacent to one another thereby forming channels within the single molded piece. The channels formed in the single molded piece include both light emitting channels and light receiving channels. Next, in step 106, at least a portion of the assembled housing is embedded in a polishing pad backer such that ends of the light emitting channels and ends of the light receiving channels are positioned near a window in a polishing pad such that light emitted from the light emitting channels can be directed to a wafer surface and light reflected from the wafer surface can be received by the light receiving channels. A light source is then connected to the light emitting channels in step 108 so that light can be emitted through the light emitting channels and a light detector is connected to the light receiving channels in step 110 so that light reflected from the wafer surface can be directed to the light detector through the light receiving channels.

Alternatively, instead of steps 108 and 110, the following steps may be performed subsequent to embedding at least a portion of the assembled housing into a polishing pad backer in step 106: a) the light emitting channels are secured to a first connector positioned outside of the pad backer in step 112, b) a light source is connected to the first connector in step 114 such that light emitted from the light source is transported to the wafer surface through the first connector and the light emitting channels, c) the light receiving channels are connected to a second connector positioned outside of the pad backer in step 116, and d) the second connector is connected to the light receiving channels in step 118 so that light reflected from the wafer surface is transported to the light detector through the light receiving channels and the second connector.

The present invention has been described above with reference to exemplary embodiments. However, those skilled in the art having read this disclosure will recognize that changes and modifications may be made to the exemplary embodiments without departing from the scope of the present invention. these and other changes or modifications are intended to be included within the scope of the present invention, as expressed in the following claims.

We claim:

1. An apparatus for in situ endpoint detection during chemical mechanical planarization comprising:
a sensor block positioned within a polishing pad backer, said sensor block having at least one light emitting channel and at least one light receiving channel for receiving reflected light; and
means for determining endpoint based on an amount of reflected light that is received.

2. The apparatus of claim 1 wherein said sensor block includes an opening therein.

3. The apparatus of claim 2 wherein said light emitting channel terminates at said opening and said light receiving channel originates at said opening.

4. The apparatus of claim 3 wherein said opening is filled with an optically clear material.

5. The apparatus of claim 1 further comprising a fiber optic cable positioned in each of said light emitting and receiving channels.

6. The apparatus of claim 1 wherein said light emitting and receiving channels are coated with a reflective coating and filled with an optically clear material.

7. The apparatus of claim 1 further comprising a first connector connecting a means for emitting light to light emitting channels and a second connector connecting light receiving channels to a means for detecting light.

8. The apparatus of claim 1 further comprising a plurality of fiber optic cables embedded in said polishing pad backer wherein at least one first fiber optic cable connects said light emitting channel to a light emitting means and at least one second fiber optic cable connects said light receiving channel to a light detecting means.

9. The apparatus of claim 8 further comprising a first connector connecting said first fiber optic cable to said light emitting means and a second connector connecting said second fiber optic cable to said light detecting means.

10. An in situ multi-angle endpoint detection apparatus for CMP comprising:
a sensor assembly wherein at least a portion of said sensor assembly is positioned within a polishing pad backer;
light emitting means positioned outside of said polishing pad backer;
light detecting means positioned outside of said polishing pad backer;
a plurality of light emitting channels contained in said sensor assembly wherein said light emitting channels are connected to said light emitting means; and
a plurality of light detecting channels contained in said sensor assembly wherein said light detecting channels are connected said to said light detecting means.

11. The apparatus of claim 10 wherein at least a portion of said plurality of light emitting channels and light detecting channels are located behind said polishing pad backer.

12. The apparatus of claim 10 further comprising a first connector connecting said light emitting means to said light emitting channels and a second connector connecting said light detecting means to said light detecting channels.

13. The apparatus of claim 10 further comprising a plurality of fiber optic cables positioned in said plurality of light emitting channels and light detecting channels.

14. The apparatus of claim 10 wherein said plurality of light emitting channels and light detecting channels are coated with a reflective coating and filled with an optically clear material.

15. The apparatus of claim 10 further comprising a polishing pad having a window therethrough wherein at least a portion of said sensor assembly is positioned beneath said window.

16. The apparatus of claim 10 wherein said sensor assembly includes an opening.

17. The apparatus of claim 16 wherein said opening is filled with an optically clear material.

18. The apparatus of claim 16 wherein said light emitting channels terminate at said opening and said light detecting channels originate at said opening.

19. The apparatus of claim 18 further comprising a polishing pad having a window therethrough wherein said opening in said sensor assembly is positioned beneath said window.

20. A sensor block for in situ multi-angle endpoint detection during CMP comprising:
a housing;
an opening in said housing;
a plurality of light emitting channels contained in said housing and terminating at said opening; and
a plurality of light detecting channels contained in said housing and originating at said opening.

21. The sensor block of claim 20 wherein said opening is filled with an optically clear material.

22. The sensor block of claim 20 further comprising a fiber optic cable contained in each of said light emitting and light detecting channels.

23. The sensor block of claim 20 wherein each of said light emitting and light detecting channels is coated with a reflective coating and filled with an optically clear material.

24. A method for making an apparatus for in situ endpoint detection during CMP comprising the steps of:
molding a housing assembly having a first half and a second half, each half containing a set of grooves formed therein;
securing said first and second halves of said molded housing assembly together such that said grooves lie adjacent one another to form at least a first and second channel contained within said housing assembly, each channel having first and second ends;
embedding at least a portion of said assembled housing in a polishing pad backer;
connecting a light emitting means to the first end of the first channel; and
connecting a light detecting means to the second end of the second channel.

25. The method of claim 24 wherein said step of securing said first and second halves further comprises the step of creating an opening in said molded housing assembly wherein the second end of the first channel terminates at said opening and the first end of the second channel originates at said opening.

26. The method of claim 24 further comprising the step of positioning a fiber optic cable in said first and second channels.

27. The method of claim 24 further comprising the steps of:
coating said first and second channels with a reflective coating; and
filling said first and second channels with an optically clear material.

28. The method of claim 24 further comprising the steps of:
positioning and securing a connector between the light emitting means and the first end of the first channel; and
positioning and securing a connector between the second end of the second channel and the light detecting means.

29. The method of claim 24 further comprising the step of inserting at least one fiber optic cable embedded in said polishing pad backer between each of said first and second channels and said light emitting and detecting means, respectively.

30. The method of claim 29 further comprising the steps of:
positioning and securing a first connector between the first fiber optic cable and the light emitting means; and
positioning and securing a second connector between the second fiber optic cable and the light detecting means.

31. A method for detecting endpoint in situ during CMP comprising the steps of:
positioning a sensor block having at least one light emitting channel and at least one light detecting channel in a polishing pad backer;
positioning a polishing pad having a window over said polishing pad backer such that an end of each of said light emitting and detecting channels lies adjacent said window;
emitting light through said light emitting channel during CMP;
detecting light reflected from a wafer surface during CMP through said light detecting channels; and
determining endpoint based on an amount of light reflected from said wafer surface.
